(19) United States
(12) Patent Application Publication
(10) Pub. No.: US 2003/0001510 A1
(43) Pub. Date: Jan. 2, 2003

(54) MAGNETO-HYDRODYNAMIC POWER CELL USING ATOMIC CONVERSION OF ENERGY, PLASMA AND FIELD IONIZATION

(76) Inventor: Christian Vahab, Westminster, CA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 09/894,104

(22) Filed: Jun. 27, 2001

(51) Int. Cl. H01J 17/26

(52) U.S. Cl. 315/111.21; 313/231.31

(57) ABSTRACT

A method of operating an electric current producing power cell comprising precharging the power cell; applying a current to heat a bi-metal heating element; applying voltages so as to cause a first cell to assume exhaust gas motion; irradiating gases in an alternate cell to force gas movement in a direction, away from a negatively charged collecting plate; producing a high internal gas temperature through molecule collisions to cause gas expansion; conducting the gas mix at high speed through a plasma discharge channel in a direction perpendicular to an impressed magnetic field; and drawing an electric current produced thereby; reversing electrical charges and repeating the process continuously in each of the alternate cells.

### BACKGROUND OF THE INVENTION

1. Field of the Invention

This invention relates generally to the generation of electricity in an energy cell process and more particularly to the structure and method of producing electricity by magnetohydrodynamic (MHD) conversion driven by a nuclear irradiation process.

2. Description of Related Art

The following art defines the present state of this field:

Ruben, U.S. Pat. No. 1,916,235 describes a system for obtaining a rapid remote control which comprises the combination of an electrolytic chamber containing electrodes and a solution capable of rapidly giving off oxygen and hydrogen when electrolyzed, a piston chamber connected to said electrolytic chamber and housing a piston movably responsive to the pressure generated in said chamber and adapted to control the movement of an exterior rotary motion device, a heater wire to recombine the generated gases located within said electrolytic chamber, and means for selectively energizing the electrodes of said electrolytic chamber or the said heater wire.

Hartley, U.S. Pat. No. 2,532,096 describes a source of oscillatory energy which comprises a substantially vertical closed cylinder vessel having at its upper end a rigid plate and at its lower end a flexible plate, a mass of vaporizable liquid substantially filling said vessel, means for applying heat to said rigid plate so as to form bubbles of vapor at the upper surface of said liquid mass and impress and impulse on said liquid mass with a consequent relative movement of said upper surface, all tending to set up pressure waves in said mass, and cooling means positioned slightly below the upper level of said surface but close enough thereto to transmit a condenser action to said vapor only near the lower extreme of movement of said upper surface, whereby, when taken in connection with the condenser action at said surface by the return impulse after reflection from the flexible plate at the lower end of said vessel, a cyclical energization of said mass is promoted and perpetuated and energy may be produced by vibration of said flexible plate.

Dickey, U.S. Pat. No. 2,548,708 describes a means for transforming electrical energy into mechanical force including a chamber containing a small amount of vaporizable liquid, electrical heating means for said liquid, a cylinder adjacent the chamber, a piston in said cylinder movable by the pressure generated by vaporization of the liquid by the heating current means for controlling the heating current to thereby control actuation of the piston, a second piston in the cylinder adapted to be moved by the first piston means including a rod connecting the second piston to a load, locking means preventing return movement of the load after actuation thereof, and means for releasing the lock, including further a closure for the cylinder having a restricted opening cooperating with said second piston to act as a dashpot to control the return movement of the load.

Seversky, U.S. Pat. No. 3,130,945 describes a combination flying apparatus composed of a structure supporting discharge electrodes for causing adjacent air molecules to become electrically charged spaced from a grid of electrical conducting means for neutralizing the charge on electrically charged molecules whose charge was caused by said discharge electrode and means for applying a high D.C. potential between said electrodes and said grid to cause air to move from said electrodes toward said grids to provide a propulsion force for said flying apparatus, and antenna means for use with radio frequency energy signals, said antenna comprising a plurality of elements which serve also as part of said structure for the flying apparatus by being connected electrically to one terminal of said high D.C. potential to assist in providing propulsion force for said apparatus.

Papp, U.S. Pat. No. 3,670,494 describes a method of utilizing potential energy of atoms and various forms of radiation (electrons, photons, gamma beta and alpha radiations, etc.) in a controlled power generating system; effective mixtures of chemical elements adapted for use in the method; the preparations of charges of ingredients for use in virtually gas-tight power generating devices; the activation and control of such charges and devices; structural requirements of power generating devices utilizing the methods and compositions.

The present invention clearly distinguishes over the above art and provides further related advantages as described in the following summary.

### SUMMARY OF THE INVENTION

The present invention teaches certain benefits in construction and use which give rise to the objectives described below.

Marks' Standard Handbook for Mechanical Engineers (Tenth Edition) McGraw Hill—publisher, page 9-26, reveals that the magnetohydrodynamic effect yields high voltage, direct current (dc) output, and potentially alternating current (ac). It further describes that in a simple open-cycle system, an MHD machine uses hot, partially ionized compressed gases, which are the product of some form of combustion. These partially ionized gases are expanded in a duct and are further forced through a strong magnetic field. Electrodes on the side of the duct pick up the potential generated in the gas, so that current flows in the gas, electrodes and external load. Traditionally temperatures between 3000 degrees Kelvin are required to produce an appropriate level of ionization in the gas. In order to lower the temperature to 2750 degrees Kelvin a seeding process using various metals such as cesium or potassium has been employed. In this version, the temperature of the gas leaving the generator is about 2,750 degrees Kelvin. The efficiency of such an open-cycle system was reported to be on the order of 70%. The gases need to be cooled and this is conventionally accomplished by a steam cycle used for co-generation. Contrasted with other methods for direct conversion, traditional MHD generation appears best suited to large blocks of power. Serious material problems have been experienced in these processes including severe erosion, corrosion, and thermal stresses in the electrodes, insulators and other portions of the machine.

While the MHD topping cycle offers the highest peak cycle temperature and thermodynamics cycle efficiency of any other energy producing system, none of the traditional generators tested have reached an efficiency level sufficient to account for even half of the power required to supply an oxidant to a combustor.

The principal object of the present invention is to provide a novel scalable MHD closed-loop device (the power cell). This power cell is hermetically sealed, with a pre-charged energy supply providing ongoing continuous operation. It is capable of operating tens of thousands of hours without refueling. The power cell uses Papp's atomic energy conversion method (U.S. Pat. No. 3,670,494 June 1972) to create an ionized stream of moving, electrically conducting, mixture of gases. The gases include noble gases, de-mineralized, de-oxygenated water, seed conductive metal vapor, and other material capable of emitting beta and gamma rays and electrons. The superheated gases cross a strong magnetic field in order to produce direct current (dc) electricity. Alternately, a switch controlling the direction of the magnetic field is therefore able to create alternating (ac) electricity. The benefit of this system is that under induced plasma conditions produced by an electrode system of platinum points, or an external laser irradiation, and a rapid pulsing of charges, in excess of 500 pulses per second, the power-cell will yield more internal radiation thus leading to rapid atomic structure transformations. These atomic energy transformations provide the ideal medium for a closed-loop ionized, high velocity, gaseous MHD system.

In the present invention, due to internal high pressures created by a rapid rise in inner gas temperature, the ionized gas mixture is forced to cross a strong magnetic field provided by electromagnets. Two electrodes set on each side of a gas transfer duct which is used to house the moving ionized gases in order to cross a magnetic field, collect the potential in the gases to produce dc or ac electricity. Alternative current, as has been mentioned, is obtained by reversing the polarity of the electromagnets reversals in the direction of electric current flow.

This closed-cycle MHD generation of electricity through atomic conversion of energy offers the potential for high efficiency with considerably lower peak cycle temperatures, lower pressure ratios, and lower average magnetic-flux density. Furthermore, the super-heated gases passing the magnetic field, are cooled and returned for each next cycle of atomic energy conversion. Beside potential and optional external cooling by gases or liquids, the process of internal cooling specified by Papp would allow the construction of relatively small but scalable power-cell devices, which could operate in a lower as well as a higher electrical and kinetic energy generation spectrum.

When one of the activating cells emit gamma rays, which have no negative or positive charge and will not be absorbed by the gases nor by the electric components of the chambers, will cause structural changes in the molecules of the argon an other gas element in the mixture, which has been also subjected to radiation from the other activating cell that itself has been subjected to the supplied ac and dc. charges. During operation, fluorescence and luminosity is highly desirable. In order to stimulate such fluorescence and luminosity the activating cells are sequentially supplied with current as previously stated, and optional by the IR laser radiation. Electrons emissions are stimulated or induced and electrons from one cell are attracted toward the other, the flow of these electrons resulting in an electric current. The strength or potential of this current is increased by the presence of certain gases Argon, Neon, Krypton, Xenon, etc. as well as the quantities and the pressure within the cell.

The cathode also must emit beta rays and gamma rays. The gamma rays will induce certain materials to radiate fluorescence light. This has a special function at the expended position, and aid by cooling the walls of the activating chamber. Heat is removed from the IPAC-MHD power cell's walls because elementary particles are retrieved from the walls, such particles have previously been emanated from the cathode rays. Within the confines of the chamber, the gas mix molecules collide with the walls and other gas molecules and change direction; oppositely moving positive and negative molecules attract each other, but the neutral molecules will not be able to participate in the current. To increase the number of charged particles the speed is increased so to reduce the number of recombination's which tends to result in neutral equilibrium. By accelerating the power source of motion, the charged molecules will explode them to nascent particles which are capable of taking charges while the forces upon them will begin to move the charged particles in positive and negative direction and into further collisions where they create new charge carrying particles. X-rays created by the cathode knockout or dislodge atoms from the xenon in the gas mix and atoms, that have lost one or more of their electrons, will suffer an electron deficiency. Thus the atoms will have a positive charge, while the lost electrons will be picked up by the argon, neon and/or krypton isotopes in the gas mix. The gas which accepts the electrons will have a negative charge. The xenon will replace its lost electrons from the negatively charged collector plate. The element in one of the cells should be capable of emanating alpha ray particles, actinium, for example, so as to produce a fluorescence or luminescence that encourages beta and gamma propagation. Phosphorus, mesothorium, radium or actinium can be employed. The alpha ray particles collide with the zinc sulfide crystals on the collection plate. In addition, these elements also create ultraviolet rays which also force electrons to emanate from the zinc, aluminum or other metals which could be employed for the housing of the cell. The photons thus obtained are of value in that their removal from the metal walls assist cooling. During the compression and the desired equilibrium in pressure when the gas mix is injected into the activating chamber, ac current is stopped and dc current is once again supplied. The “Neutral Electrons” which were forced to explode loose their charges and will again become “Neutral Electrons”, this is because the collector will retrieve their charges. The xenon gas is in need of charges and it will re-assimilate its lost electrons from the argon and neon. The huge electron surplus originally admitted via the cathode will migrate through the closed circuit of the controller and will drain extra electrons, which controller has dedicated to components set outside the internal electron system. The quantity of electrons, which are returned by the AC/DC Converter-controller at the top of the compression stroke, combined with the low EMF current from the controller generator results in a very powerful charge to the previously charged collector plate inside the cylinder, resulting in a high explosive discharge at the top of the stroke. The radiation of the phosphorous or alternatives in the cathode activating cell will be reduced, almost stopped with the exception of the gamma rays because the current of electrons will now have an opposite direction polarity result in an opposite charge. The same will happen with the rubidium in the anode, even in its radiating capacity will be intensified to a certain degree, with the aid of the charge laden electron current. The same will happen with the electrons and particles which will be released from the IPAC-MHD power cell wall and which will result with the aid of water vapor in a reduction or loss of sensible heat. The IPAC-MHD power cell's wall will cool and it will cool the hot gases and the high pressure dry water steam. Small amount of water vapor will even condense on the activating chamber's wall. Total and complete condensation of the water and cooling cannot occur because within a fraction of a second, the heating cycle will commence again. This cooling, however will improve with the exchange of heat from the ionized gas mix returning into the chamber via an injection tubing which will be flooded with external coolants pumped in my various common methods. The rubidium ways in the activating cell will emit alpha and gamma rays intensified during the reversed polarity compression cycle. At the moment of the next discharge between the gap points 19 and the laser pulse, 80 to 85% of the water will become moist steam and 15 to 20 percent will condense to liquid water. The resultant residue will settle on the chamber's wall and it will be chemically harmless, because it consists of atrophied electrons of the electricity.

This cycle of charges and discharges will continue for as long as the controller dictates, and or until the activating cells compounds' half-life comes to an end. Due to the lack of oxygen in the system and the mix-composition of noble gases, the mix is not expected to degrade, and depending upon the tightness of the seals of the device, the life expectancy of the system is within thousands of continuous operation hours.

A primary objective of the present invention is to provide an apparatus and method of use of such apparatus that provides advantages not taught by the prior art.

Another objective is to provide such an invention capable of producing electrical power over an extended period of time limited only by an irradiation material charge capacity and life cycle.

A further objective is to provide such an invention of only a few cubic inches in size and capable of providing a power output of several kilowatts.

A still further objective is to provide such an invention capable of being easily scaled.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective schematic view of the preferred embodiment of the invention, a sealed MHD power cell referred to herein as an Ionic-Charged Plasma Atomic Conversion Power Cell, or IPAC power cell for short;

FIG. 1A schematic diagram showing operation of the power cell;

FIG. 2 is a schematic diagram the general concept for the power cell, inclusive of a segment of an ionic-discharge with a computer controlled distribution network;

FIG. 3 is a section view taken along line A-A in FIG. 1 and showing a layout of the power cell;

FIG. 4 is a view of one side of the power cell showing electrical terminal connections and accessible intakes for injection of a gas-mixture;

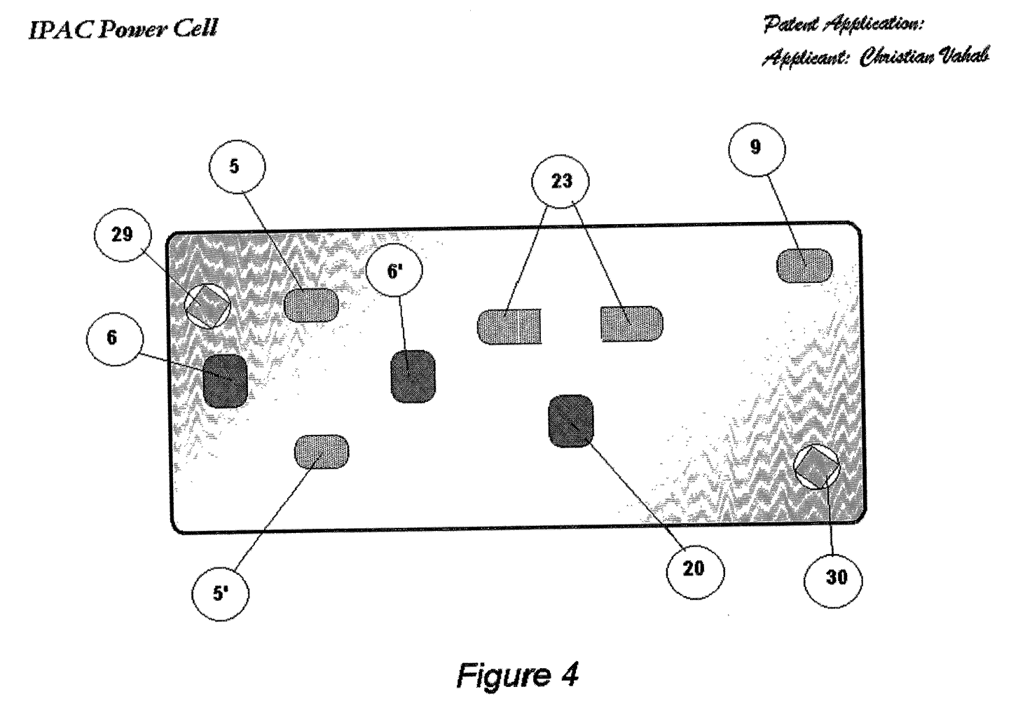

FIG. 5 is a section view taken along line B-B in FIG. 1 and showing activating cells of the power cell;

FIG. 6 is schematic view of a factory charge system and procedure for the gas-mixture;

FIG. 7 is a process flow diagram of operation of the power cell;

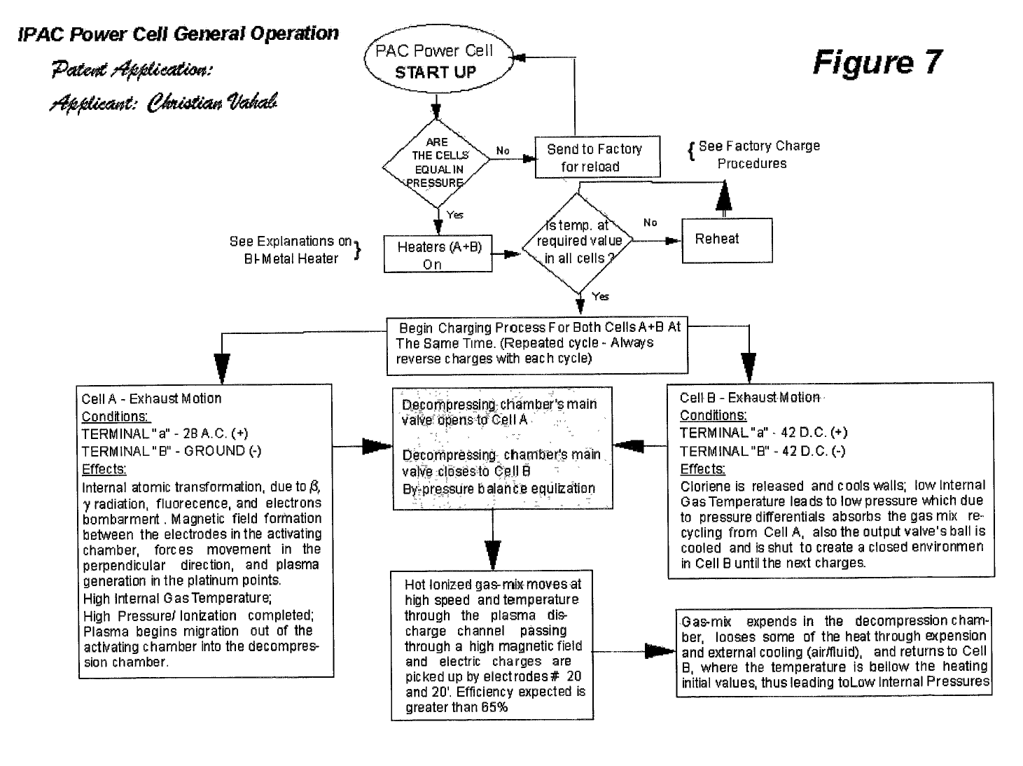

FIG. 8 is a chart showing time related changes in various parts of the power cell during operation; and

FIG. 9 is a perspective view of a current generating portion of the power cell and a corresponding electrical schematic representation thereof.

### DETAILED DESCRIPTION OF THE INVENTION

The above described drawing figures illustrate the invention in at least one of its preferred embodiments, which is further defined in detail in the following description.

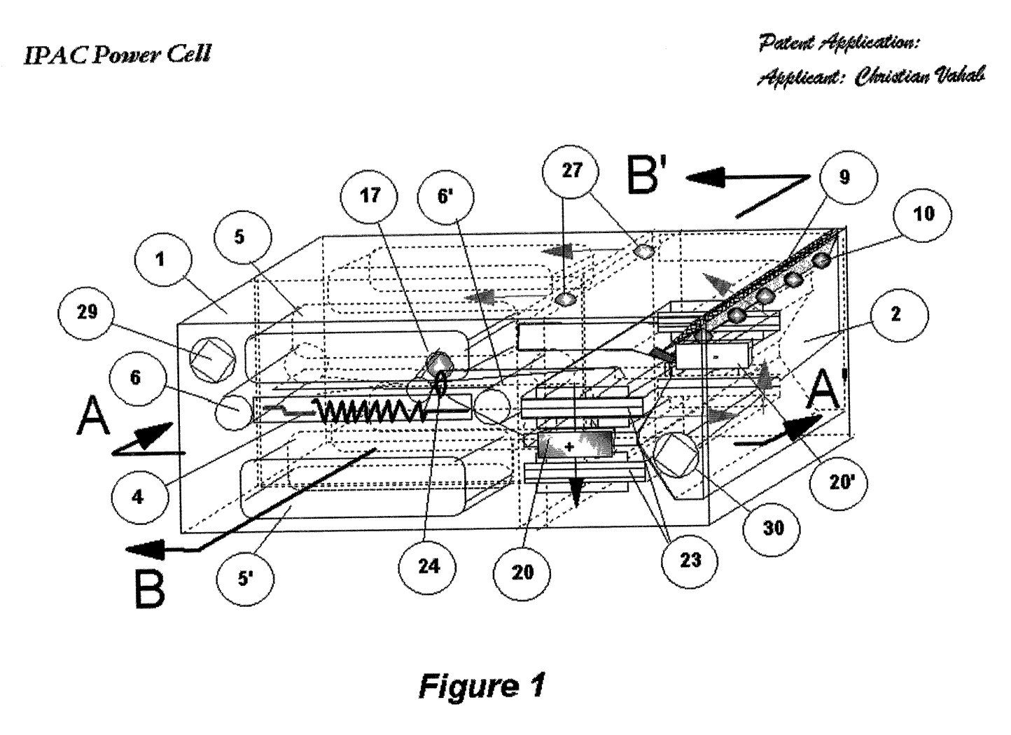

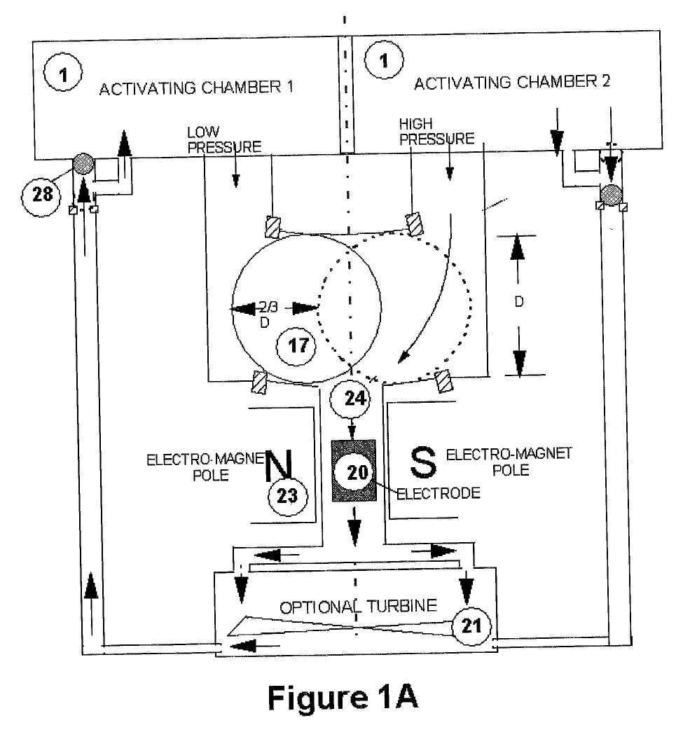

The present invention is a power cell, and as shown in FIG. 1, it is a hermetically sealed device, which is factory pre-charged at a selected pressure with a mixture of gases. The invention is comprised of several elements. Among these, but without any limitation to alternative designs, are items defined by numerals 4, 5, 5′, 6, 6′, 7, and 19, which are enclosed within a highly reflective, coated, single pressure, discharge chamber, which we shall refer to herein as an activating chamber 1. Two such activating chambers 1, referred to as chamber A and chamber B are provided and are connected to each other via a check valve 27 with a moving ball 28. A plasma discharge channel 12 connects the activating chambers A, B to a decompression chamber 2. Within each of the activating chambers there are two activating cells, which shall be referred to as an anode 5′ and a cathode 5. These are filled with sources of alpha, beta, and gamma ray emitting materials. The cathode 5 is constructed of an aluminum alloy containing a high content of antimony and cesium and is filled with approximately one gram of at least 99.5% pure red phosphorous mixed into argon gas at 20 atmospheres. The anode 5′ is constructed of stainless steel and is filled with 620 milligrams of rubidium mixed into 20% refined mineral oil and 80% argon gas at 20 atmospheres. Two electrodes 6 and 6′ are constructed of copper and support a bimetallic heater 4 which has a heating filament protected by a perforated metal envelope. A collecting plate 7 hangs from the two electrodes 6 and 6′ via thin insulators 8 which short-out through the electrodes 6 and 6′ at a high potential charge, between 12-24 volts dc. The collecting plate 7 is constructed of an alloy containing high doses of antimony and cesium, or an aluminum alloy containing zinc sulfate. Two discharge electrodes 19 are made of platinum with points separated by 0.062 inches and are inserted into the cavity so as to be immersed in the water within the system. The gas mixture is pre-charged and may contain approximately 2% by weight of liquid metal, or any other conductive liquid or gaseous element in lieu of water. This supports electric charge transmission when exhausted, super heated metal vapors, move out of the activating chamber 1 into the decompressing chamber 2 via the plasma discharge channel 12.

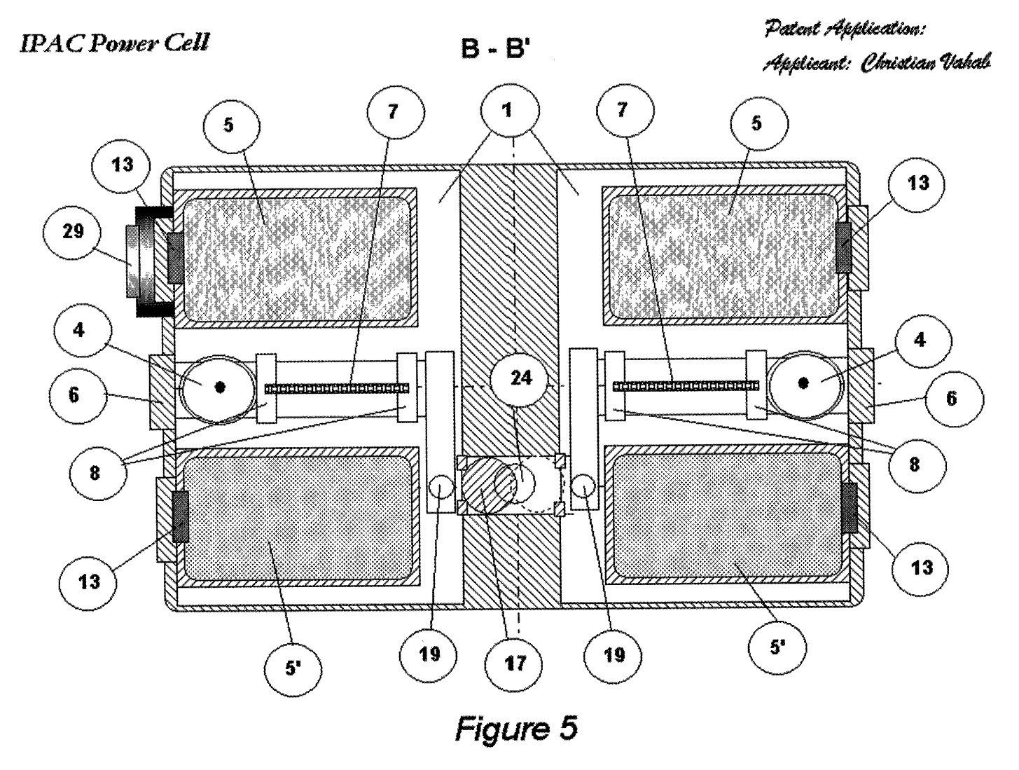

While the super heated ionized gas mixture escapes the activating chamber 1 it is exposed to a high magnetic field produced by electromagnets 23. In one embodiment, the direction of current flow within the circuit of each of the electromagnets 23 is switched in polarity at a selected frequency so to produce an alternate current at the collector electrodes 20. Likewise a dc voltage can be produced at electrodes 20 by providing a unidirectional current flow in the electromagnets 23, as shown in FIG. 5.

The decompression chamber 2 incorporates two grids 9 and 10 which are charged at a negative potential at grid 10 and produces a positive current in grid 9. This produces further ionization to accelerate the expanding gas particles in order to ease the migration of the cooled gas mixture into the activating chambers A and B.

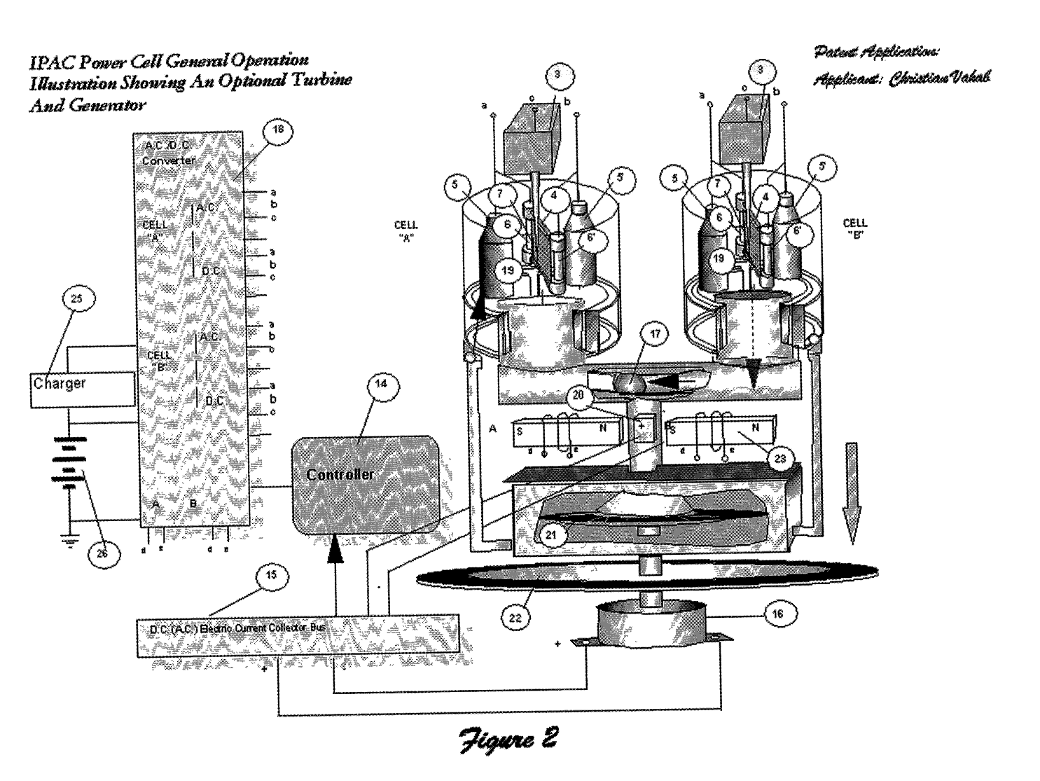

FIGS. 1A and 2 are general illustrations of the power cell in concept form and showing the optional laser 3 for plasma ionization induction, and which emits under computer control in the infrared spectrum at a high pulse intensity, and also an auxiliary turbine 22 which converts its kinetic energy into electric energy via a standard electrical generator set 16. The power cell is also controlled and receives electrical energy via an ac to dc converter 18 controlled by a microprocessor 16.

A 24 VDC battery 26 is used at start-up and it is recharged, once the power cell is operating, via a charger 25. A DC/AC bus collects the dc or ac current of the system once it is in full operation.

FIG. 1A emphasis the idea of a valve 28 which operates on sequential imbalance pressures. For example, at the same time that pressure is raised in chamber A, the pressure is dramatically lowered in chamber B, which forces the valve 28 to close chamber B which is at a lower pressure, an essential condition. The closed chamber B having a low pressure, beyond the pressure generated in the decompression chamber 2, fills with exhaust hot gases from chamber A. Once the majority of the gas mixture leaves chamber A, the charges are reversed and chamber B now is exposed to hot rising temperature and higher pressures, while chamber A instantly lowers its temperature, thus shutting down the valve in the opposite direction and sucking in the gas mixture coming through the decompression chamber 2. The system comes into equilibrium only when it is shut down and both chambers cool to equal temperatures and pressures. Similarly the valve 28 also operates on a sequential imbalance pressure. Thus, when the pressure in one chamber rises, it shuts off the valve in the direction opposite to the direction of the decompressed gas mixture. When the temperature in that chamber lowers dramatically, also lowering the pressure, the valve opens and the gas mixture exhausts under higher pressure moving from the the decompression chamber 2 so as to fill the alternate activating chamber.

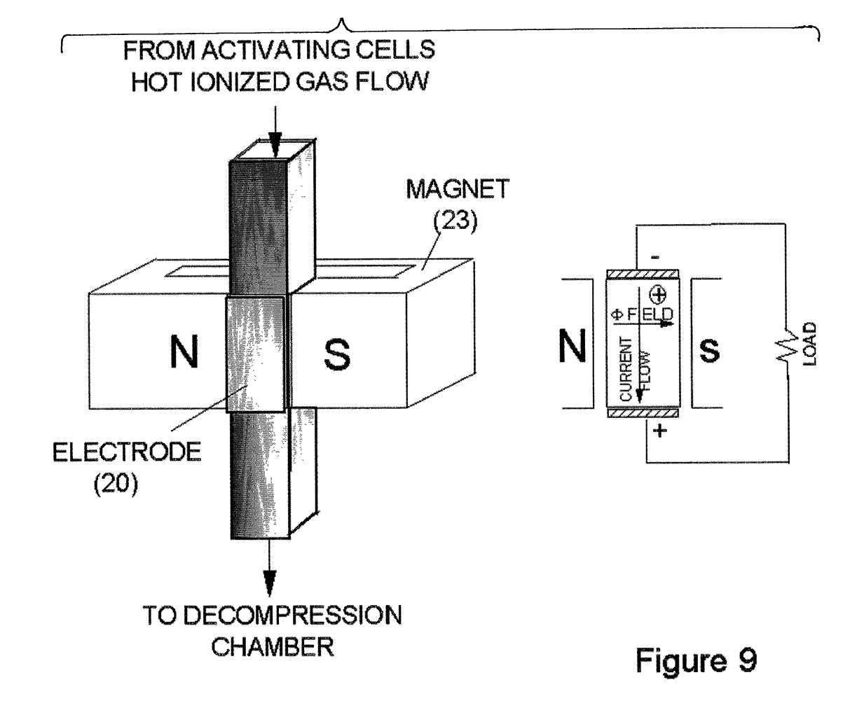

FIG. 9 shows the way the hot ionized gases coming from the two activating chambers, pass the main valve, and move through the magnetic field to produce dc current through the electrodes 20 and 20′.

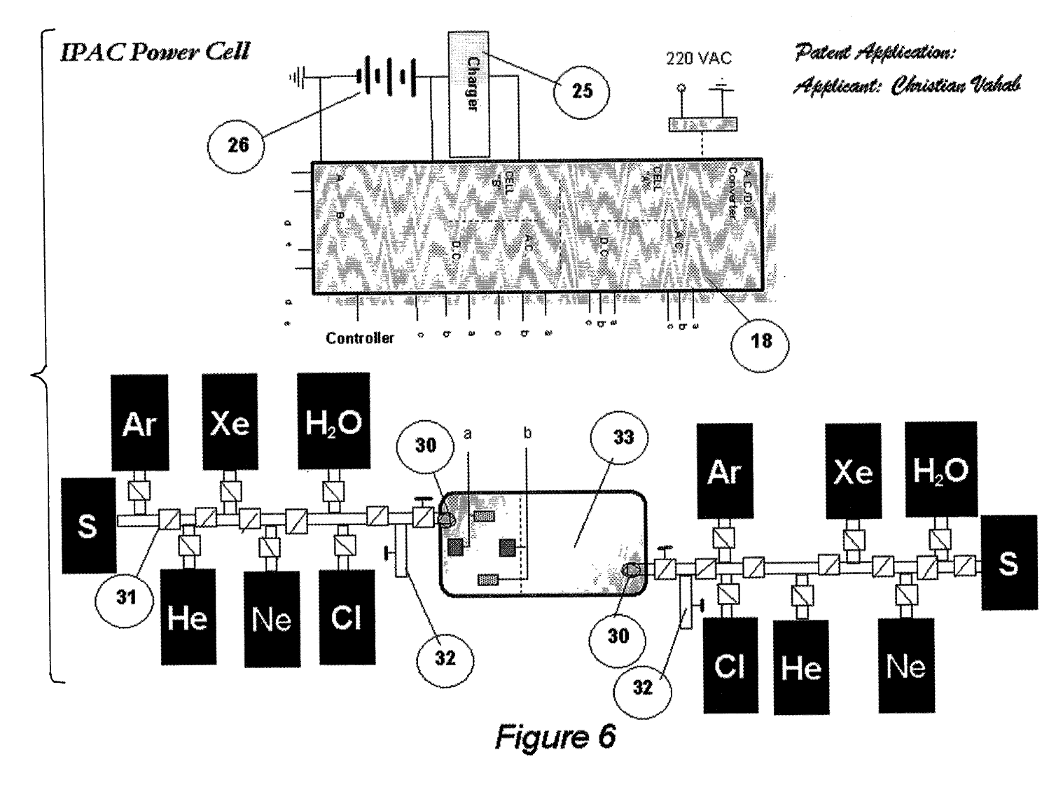

In order to pre-charge the power cell a special pumping mechanism or device is employed, as shown in FIG. 6. Two such devices are mounted to the injection gas-mix valves 29 and 29′ for enabling the activating chamber compressed condition and for the decompression chamber 2 decompression, or exhaust condition. The two devices are mounted to an Argon (Ar) bottle, Xenon (Xe) bottle, Helium (He) bottle, Neon (Ne) bottle, Chlorine (Cl) bottle, source of de-oxygenated, de-mineralized water (H₂O), and finally a pump containing the seed metal material such as potassium, cesium, mercury, etc.

With the pump connected to the activating cells A and B (29 & 29′) operating equally and at the same time, 100 percent of volume of deoxygenated water is injected into the activating chamber cell A and B; having both chambers filled at the same time and to the same pressure which is crucial since the check valve between chamber A and B is governed by a shut-off ball which must be in a center position in order to keep the plasma discharge channel closed. The ball operates off a pressure imbalance in the two activating chambers A and B; in other words when the pressure is high in A and low in B, the ball in the check-valve will shut down the escape in cell B (the lower pressure cell) so the cell B (in normal operation) can be refilled until the pressure in A lowers.

A mixture of 60 percent neon and 40 percent chlorine is now simultaneously injected into the two activating chambers until 30 percent of the water is expelled through the discharge valve 32. The contents are then cycled, agitated, or otherwise mixed to cause some of the chlorine to become absorbed by the water.

A mixture of 60-70 percent xenon with approximately 30-40 percent chlorine, is then injected until an additional 40 percent of the original volume of decomposed water is expelled by this step of gas injection. The contents are again cycled, agitated or otherwise mixed thoroughly. Unidirectional valves 31 help keep the gases from moving away from the power cell.

The above procedure is repeated with respect to the decompressing chamber by applying the same charges though the injection gas mix valve 30.

A mixture composed of about 65 percent argon, 25 percent xenon and 10 percent neon is injected in the activating chamber, as well as into the decompression chamber, once again until a sufficient amount of water is displaced so as to seal the system and to leave only 8 percent water.

The system is now filled with 2% by weight of liquid gallium mercury, potassium, or cesium, which replaces more water.

Once more 65 percent argon, 24 percent xenon and 9 percent neon is injected at between 3.0 atmospheres. The cell injection feeding ports are now closed and sealed.

The gases and liquid metal under approximately 3 atmospheres, are ionized by charging with a 220 volt current for a period of eight hours, although a longer time may be required when the volumes are larger, and lower potentials are used with the charging current. Ionization of the charge may be conveniently accomplished by supplying the current through terminals 5 or 5′ of an actuating cell and adjacent electrode, as shown in FIG. 5 and FIG. 6.

This method of pre-charging may vary with design, depending upon many factors including cell size, pressure and so on.

### Operating Procedures

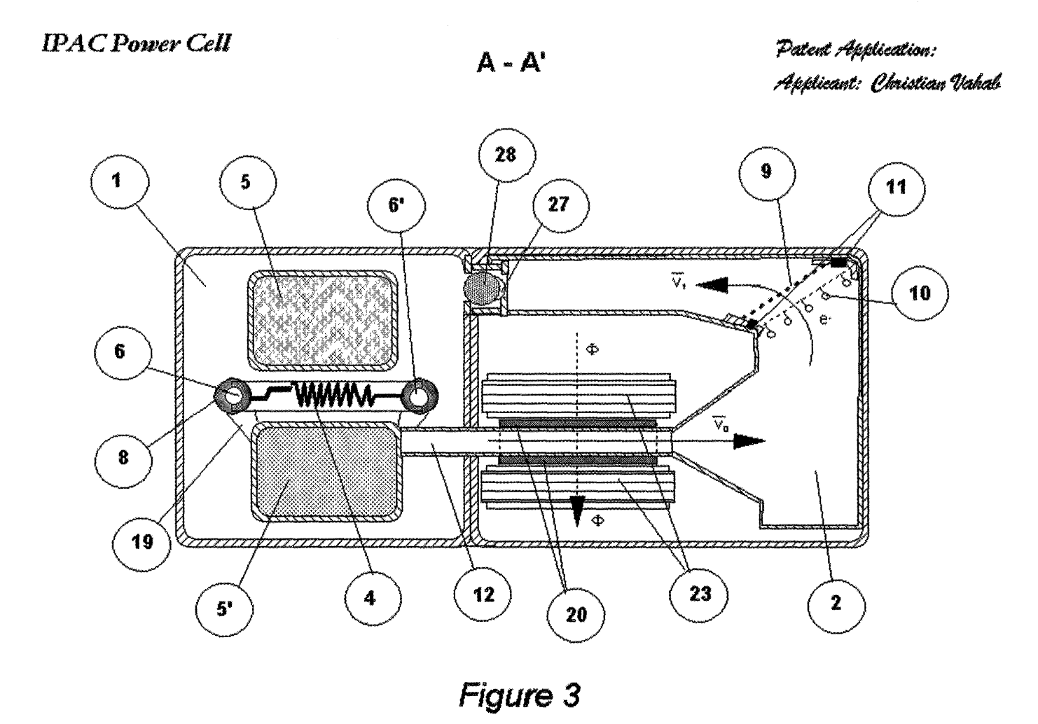

Once the pre-charge procedure is completed, the power cell can begin its operation. The cells A and B are in equilibrium, where the pressure in both cells is the same. The ball 17 in the main check valve 24, FIG. 5, is in the center and it closes the opening to the plasma discharge channel 12, FIG. 3. FIG. 1A describes the procedures for operation. Once equilibrium is established a current from the battery 26 is applied to the electrodes 6 and 6′ in order for the gas-mixture to be heated by the bi-metal heating element. Above approximately 180 degrees Fahrenheit the bi-metal heating element opens and shuts itself down. The temperature and pressure in the closed volumes of activating cells A & B rises equally. At this point 28 VAC is applied at terminal “a”, while terminal “b” is connected to the ground. Cell A assumes exhaust motion. At this point internal atomic transformations occur, due to beta, and gamma radiation, fluorescence, and electrons bombardment starts. Magnetic field formation between the electrodes 6 and 6′ in the activating chamber A forces movement in a perpendicular direction, and away from the collecting plate which is charged with a negative charge. High internal gas temperatures occur due to collision between molecules and atomic transformation as described by the Papp patent and by plasma induction through the platinum points 19 receiving current through the electrodes 6 and 6′. Given the high rate of pulsation at approximately 1000 pulses per second, applied at points a, b, and c (to point c current is applied only if a laser is to be focused to produce further short lived plasma), the temperature inside the activating chamber A can rise from 2000 degrees C. to 3000C for 1 to 2 milliseconds. Pressure rises instantly at about 20 atmospheres, in the de-oxygenated water. Also, the seed liquid metal is superheated and vaporizes. At this point the gas ionization is completed. Plasma begins migration out of the activating chamber and into the decompression chamber.

At the same time, while the main check valve 17 in FIG. 5 closes, activating chamber B terminal “a” receives a 42 VDC, positive (+) voltage. Terminal b of cell B thus receives a negative (−) charge of 42 volts dc. Under these charges, the chlorine is released and walls are instantly cooled; low internal gas temperatures lead to low pressure, which, due to pressure differentials absorbs further gas mixture which is re-cycled from the exhausted, decompression and cooling of the gas-mixture escaping from cell A. As a result, the output main valve's ball 17 is cooled and is attracted, due to pressure differentials to shut down cell B until the next cycle. The wall of activating cell B will cool and it will cool the hot gases and the high pressure dry water steam. Small amounts of water vapor will condense on the activating chamber's wall. Total and complete condensation of the water and cooling cannot occur because within two milliseconds, the heating cycle will commence again. This cooling, however could improve with an exchange of heat from the ionized gas mix returning into the chamber via a cooling heat exchanger device well known to one of skill in the art, which will be used to flood the outside decompression chamber wall of the power cell with coolant moving into the direction of a turbofan flow (connected to an optional turbine (see FIG. 2) or via an ionization charge used as a vacuum to increase the coolant flow).

The rubidium in the anode, in the activating cell, will emit alpha and gamma rays during the reversed polarity compression cycle. At the moment of the next discharge between the gap points 19 and the laser pulse, 805 to 85% of the water will become moist steam and 15 to 20 percent will condense to liquid water. The resultant residue will settle on the chamber's wall and it will be chemically harmless, because it consists of atrophied electrons of the electricity.

The collector's plate 7 builds its charge potential. During this process excess electrons are collected on to the collector plate, producing a negative potential. At the time that the pressure is at a minimum in the activating chamber B and the pressure is at maximum in activating cell chamber A, the dc charge ceases and an ac charge is applied causing a new cycle to begin. The same reverse holds true in the activating cell chamber A where dc voltage is applied.

The collector plate 7 in chamber B will short out with high voltage through the insulators 8 which connects the plate, and through the two electrodes 6 and 6′. This is accentuated by the moist steam which results during the cooling of the super heated steam from deoxygenated water in the ionic-charged gas mix. When the gas mix is in the activating chamber compression phase, the controller, through a capacitor incorporated in the AC/DC converter board (FIG. 2), has excess of electrons at the same moment of electric discharge. The negative charge condenser attracts or absorbs positive molecules. These positive charges move toward the collector plate and negative charges are repelled while the positive ions reach the collector plate and are neutralized. Moreover, the collector plate will create an electrical barrier.

During the expansion phase of the gas mix in the activating chamber B, through the plasma discharge channel exhaust 12, the positive and negative ions which are created by gamma ray emission of the cathode, will increase in mass instantaneously by the assimilation of the electrons supplied by the controller/generator, whereby the gross pressure resultant within the chamber is increased directly and proportionally. The collision of gas atoms, electrons and molecules, results in a high heat coefficient with resultant gas expansion. The amount of heat depends upon the charge of the anode and cathode, and the charge of the collector plate. The rays from the cathode are directed downward toward the bottom of the activating chamber, perpendicular to the magnetic field created by the charged electrodes through the main valve and the plasma discharge chamber 12, from the time that the collector plate discharges its static potential previously acquired, and from the plasma discharge between the points 19 of the electrodes, which are positioned close to the bottom of the activating chamber in order to complete the electric circuit. Also this occurs during the laser pulse when optionally employed as an enhancer. Due to the presence of ionized gases and water vapor, the electromagnetic field which is created between the electrodes will be the force which will attract the otherwise directional migration of the cathode ray particles toward the bottom of the activating chamber. Simultaneously, the collector plate creates an electric barrier above such discharge and field, facilitating the downward deflection of the rays in the direction of movement of the bottom wall of the chamber.

As the ionized gas mix travels at high speed and high temperatures through the plasma discharge channel 12 and under a perpendicular magnetic field, an efficient amount of electric charges are drawn through plates 20 and 20′ (FIG. 1, 2, 3 and 4). There are two general forces acting upon the system, one force is the resultant of the anode, cathode and collector plate short-circuiting and changing the moist steam in the gas mix to a super heated dry steam. The second force is a resultant of the high temperature/pressure coefficient of the gases and the directional electrons emitting from the radiating alpha, beta, gamma materials in the activating cells 5 and 5′ [rubidium, phosphorus and/or actinium, for example] whose velocity is increased by the electrical impulses to which they are subjected. The Xenon and other gases in the mixture will contribute to the magnetohydrodynamic effect electrical collection during its high velocity passage through the perpendicular magnetic flux exercised by the magnet positioned between the activating and decompression chamber and around the exhaust elements.

An IPAC-MHD power cell with a dual activating cell has been modeled in accordance with Papp's engine. The IPAC-MHD sealed power cell with a gross single activating chamber volume of 0.698 cubic inches 11.4 cubic centimeters and operating at a charge cycle of 1000 Hz 1000 pulses per second would yield 14 kWe 19 hpe of dc electrical current. The IPAC-MHD power cell uses a cathode activating cell made of aluminum and filled with 1 gram of 99.5% pure red phosphorus in argon@20 atmospheres. The anode activating cell is made of stainless steel and is filled with 150 milligrams of rubidium in 20% refined mineral oil +80% argon@20 atmospheres. The gap between the platinum points is 0.0625 inches 1.5875 millimeters, while the distance between the activating cells cathode and anode is 0.295 inches 7.5 millimeters. The overall size of the IPAC-MHD power cell is 3.1″ in length X 1.6″ width×1.6″ in height approximately 8 centimeters×4 centimeter×4 centimeter. The gas mix is originally injected as prescribed herein, and as per FIG. 6, and hermetically sealed for long term operation.

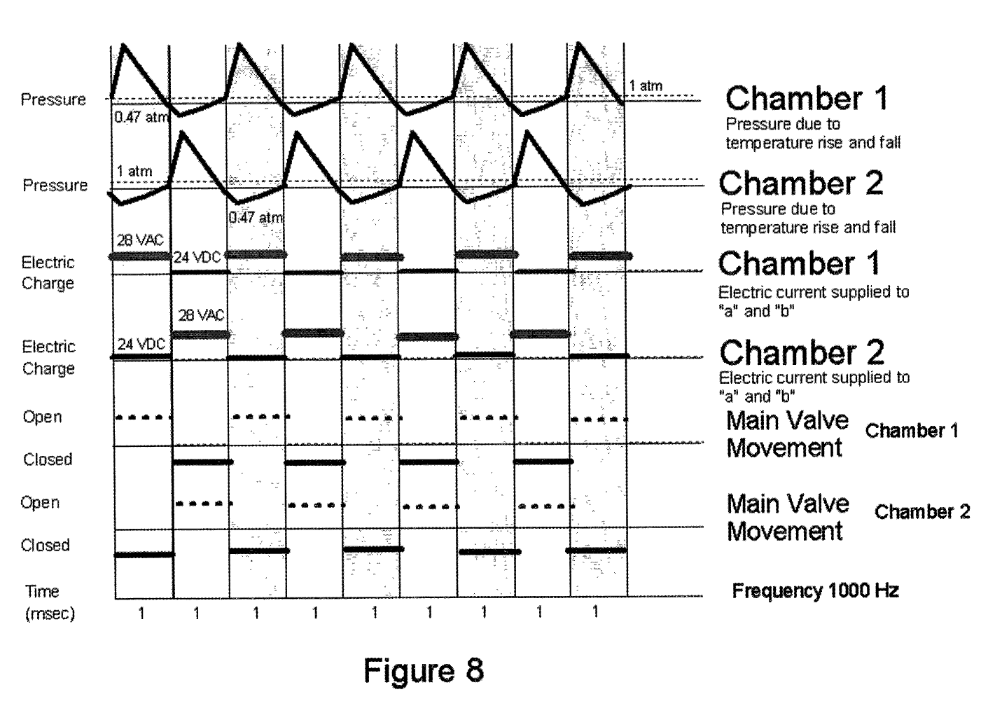

The electric charges from the controller are 24 VDC at the beginning of the compression action, and 28 VAC at the top of expansion. The stabilizing BI-metal heater maintains the steady temperature at approximately 150 degrees Fahrenheit with an approximate ambient pressure of 3 atmospheres. Maximum internal pressure at 1000 Hz and 28 VDC charge should be 20 atmospheres, while the lower pressure obtained at the beginning of compression chamber 24 VDC charge is 0.47 atmospheres. A smaller package IPAC-MHD 2 centimeters×1 centimeter×1 centimeter has demonstrated powers of 3.5 hpe 2.6 kWe. FIG. 8 give the various status of both chamber 1 and 2, under the ac and dc electric charge. Also, the position of the main valve relative to change in the time, the electric charges, and the pressures is shown.

Once the cycle begins and 28 VAC is given at the top of the cycle in chamber 1, changes occur in the gas mix and extreme high temperatures occur leading to almost instant rise in pressure. At the same time, a 24 VDC charge is given to the activating cells and electrodes in chamber 2, leading to very low temperatures approximately 70 degrees Fahrenheit; this is in comparison to the extreme high temperature in chamber 1. The low pressure thus obtained in chamber 2 will open the lateral valve and close the main valve so most of the exhaust gases from chamber 1 rushing through the plasma exhaust channel into the decompression chamber is accepted into the activating chamber 2 due to pressure differentials.

The charges are reversed and once again the process is repeated. The hot ionized plasma flows through the magnetic field continuously allowing efficient extraction of electricity at the two electrodes 20 and 20′. The cycle, in this case, repeats itself every 2 milliseconds total system's cycle is 500 Hz.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A power cell apparatus comprising: a plurality of activating chambers connected via a check valve, a plasma discharge channel connecting activating chambers to a decompression chamber; each of the activating chambers providing two activating cells filled with a source of high energy emitting materials; a cathode containing antimony, cesium and red phosphorous mixed into argon gas at high pressure, an anode containing rubidium mixed with refined mineral oil and argon gas at the high pressure, the anode and cathode supporting a bimetallic heater, a collecting plate joined with the anode and cathode and enabled so as to short-out through the anode and cathode at a selected dc voltage; a pair of discharge electrodes within a cavity and positioned so as to be immersed in water therewithin; and a gas mixture precharged with a conductive liquid.

2. The apparatus of claim 1 further comprising a high magnetic field producing means positioned for exposing the gaseous mixture to a high magnetic field.

3. The apparatus of claim 2 further comprising two grids engaged with the decompression chamber, the grids charged so as to produce a positive current for accelerating expanding gas particles in the activating chambers.

4. The apparatus of claim 3 further comprising a laser positioned for plasma ionization induction, and enabled for emitting under computer control in the infrared spectrum and at a high pulse intensity.

5. The apparatus of claim 3 further comprising a turbine enabled by an electrical generator for producing electrical current, the turbine positioned for receiving the gas mixture.

6. A method of operating an electric current producing power cell comprising the steps of raising pressure and temperature in a chamber A, while pressure and temperature is dramatically lowered in a chamber B; forcing an intervening valve 28 to close chamber B; filling chamber B with hot exhaust gases from chamber A; reversing electrical charges between chamber; exposing chamber B to hot rising temperature and higher pressures, while chamber A instantly lowers its temperature; shutting down the valve in an opposite direction and sucking in the gas mixture coming through the decompression chamber; repeating alternate charging of the chambers A and B with respect to the decompressing chamber by applying the same charges though an injection gas mix valve.

7. A method of operating an electric current producing power cell comprising precharging the power cell; applying a current to electrodes to heat a bi-metal heating element; applying voltages so as to cause a first cell to assume exhaust gas motion; irradiating gases in an alternate cell to force gas movement in a direction, away from a negatively charged collecting plate; producing a high internal gas temperature through molecule collisions to cause gas expansion; conducting the gas mix at high speed through a plasma discharge channel in a direction perpendicular to an impressed magnetic field; and drawing an electric current from a pair of electrodes; reversing electrical charges and repeating the process continuously in each of the alternate cells.
